(19) United States
(12) Patent Application Publication
(10) Pub. No.: US 2017/0330345 A1
(43) Pub. Date: Nov. 16, 2017

(54) Control System and Method of Landing an End Portion of a Freely Projecting Elongated Element, and Use of an Image Processor for Generating of Control Parameters for the Control System

(71) Applicant: Marine Aluminum AS, Avaldsnes (NO)

(72) Inventor: Loyd Arve Nornes, Skudeneshavn (NO)

(73) Assignee: Marine Aluminum AS, Avaldsnes (NO)

(21) Appl. No.: 15/526,195

(22) PCT Filed: Dec. 16, 2015
(86) PCT No.: PCT/NO2015/050247

§ 371 Date: May 11, 2017

(30) Foreign Application Priority Data
Dec. 18, 2014 (NO) 20141527

(51) Int. Cl. G06T 7/73; B64F 1/305; G06K 9/46; B63B 27/14

(52) U.S. Cl. CPC G06T 7/74; G06K 9/46; B63B 27/14; B64F 1/305; B63B 2027/141

(57) ABSTRACT

A control system and a method are for maneuvering an elongated element which projects in a pivotable manner from a foundation. The landing place is provided with a camera-readable pattern. The projecting end portion is provided with at least one camera which is arranged to imagine the graphic pattern when the end portion is near the landing place. The camera is connected in a signal-communicating manner to an image processor. The image processor is arranged to determine the position of the camera relative to the pattern by an image analysis and convert the image information into control parameters for the control system to position the projecting end portion relative to the landing place.

### FIELD

The invention relates to a control system and a method for manoeuvring an elongated element projecting in a pivotable manner from a foundation and being arranged to position a projecting end portion relative to a landing place remote from the foundation, the manoeuvring being provided by means of one or more actuators connected to the control system. The use of an image processor for generating control parameters for a control system for positioning a projecting end portion of an elongated element, which projects in a pivotable manner from a foundation, relative to a landing place remote from the foundation is described as well.

### BACKGROUND

When manoeuvring an elongated element, for example a gangway, which is pivotably supported, at one end portion, on a foundation and has an opposite, freely projecting end portion which is to be accurately positioned relative to a remotely positioned area, and the element is placed on a movable base, typically a vessel which is affected by wave motion and wind forces, or, possibly, the element is placed on a fixed base and the projecting end portion is to be positioned relative to a movable base, or both the foundation and the remote area are movable, it is necessary to control the outer end of the element for the outer end portion of the element to be positioned correctly. For a gangway which is used to make it possible for personnel to move between a vessel and an adjacent structure, for example an oil- or gas-field installation or an offshore wind turbine, it is important for the outer end portion of the gangway to be landed in the right place relative to anchoring points and stationary walkways on the structure, among other things.

The manoeuvring of such projecting elements is done, by and large, by rotating them around a vertical axis and a horizontal axis at the foundation. Besides, the projecting element may be telescopic or possibly include several horizontal rotary joints, which make it possible to fold the projecting element. The different movements are controlled by hydraulic actuators, for example, such as hydraulic cylinders and hydraulic motors. In their simplest form, the control references are the visual observation of the distance of the outer end portion to the landing place. The drawback of the prior art is that the references are inaccurate because of, among other things, the landing place not being recognizable, and the control signals are adapted to an insufficient degree to the development of the reference variables, that is to say the speed of motion of the outer end portion is adapted to an insufficient degree to the remaining distance to the landing place.

EP2623413A1 discloses a system and a method of manoeuvring a telescopic gangway between a vessel and a landing place on a marine structure by running a cable from a winch on the vessel over a pulley at the landing place and back to an outer end portion of the gangway. The gangway is then pulled out into abutment on the marine structure.

WO2012069825A1 discloses a bridge arrangement for the transfer of persons between a vessel and an offshore installation, the bridge platform being suspended in a vertically movable manner from a support structure on the vessel, and the bridge being pivotable around its supported end portion on the vessel.

NO330279B1 refers to a system for transferring crew, goods and so on between floating structures, in which a gangway is arranged on one structure and a platform is arranged on the other structure. The structures are connected to a line, which supports and guides the gangway as it is being connected and disconnected from the platform.

EP2439335A2 discloses a gangway arranged to connect a sea terminal to a ship. The gangway is telescopic and a first telescope section is supported at a first end portion by a post and at a second end portion by a supporting structure including means for moving the projecting end portion of the gangway to compensate for the movements of the ship.

WO2012021062A1 discloses a heave-compensated platform on a vessel, the platform being provided with a gangway, which is pivotably supported in the platform and is arranged to land with a projecting end portion on a target.

### SUMMARY

The invention has for its object to remedy or reduce at least one of the drawbacks of the prior art or at least provide a useful alternative to the prior art.

The object is achieved through the features, which are specified in the description below and in the claims that follow.

A control system for the reliable manoeuvring of an elongated element, especially a gangway, which is pivotably supported in and projects from a foundation and is arranged to position an outer end portion relative to a landing place remotely located from said foundation, the control system being based on a pattern formed on the object that constitutes the landing place being readable by means of a camera arranged on said end portion. The pattern is read simultaneously by at least one camera, preferably two identically oriented cameras arranged in a spaced-apart manner, wherein the at least one camera is arranged under the element near the area of the outer end portion which is to be positioned relative to the landing place and typically be set down at the landing place.

Said pattern may possibly be of a kind that only reflects infrared light from an IR-light source so as to eliminate reading errors caused by light reflections, mist, rain and so on.

The pattern is imaged by the at least one camera, and the images are analysed in an image-interpretation unit by the size of the pattern and the orientation of the pattern in the images being continuously converted into information about the distance between the at least one camera and the pattern, and in particular into information about the distance between a relevant portion of the element which is to be positioned and the landing place. When, for example, two cameras are used, the counterpart images are combined for image analysis, wherein image information like the distance between the representations of the pattern and the inter-camera distance is also included in the basis for generating information about the distance between a relevant portion of the element that is to be positioned and the landing place. The information generated from the image interpretation is converted into control parameters for actuators, which are arranged to move the element relative to the foundation, typically by means of algorithms, so that the end portion of the element is automatically placed in the correct position. Using image information from several cameras may give a better quality of the control parameters generated.

By using one object (sub-pattern) of the pattern that is to be read by the camera, for example one circle, the distance between the camera plane and the pattern could be accurately determined. If three objects are used, arranged in an equally spaced-apart manner, that is to say at the corners of an equilateral triangle, the image analysis will also indicate the rotation of the camera around an axis perpendicular to the camera plane and also the rotation of the camera around an axis coinciding with the camera plane.

When several cameras are used, an analysis of images from each of the cameras may be used for function control of the cameras in order thereby to ensure that the basis for the control signals that the control system uses is in order.

The object(s) forming the pattern may be formed in any way that will allow the pattern to be recorded by the camera. The pattern may be formed as graphic elements reproduced in colours that distinguish the elements from the base, they may be formed as cut-outs in the landing place provided with an underlying light source which ensures that the pattern is visible, and so on.

The invention is defined by the independent claims. The dependent claims define advantageous embodiments of the invention.

In a first aspect, the invention relates more specifically to a control system for manoeuvring an elongated element which projects in a pivotable manner from a foundation and which is arranged to position a projecting end portion relative to a landing place remote from the foundation, the manoeuvring being provided by means of one or more actuators connected to the control system, characterized by
the landing place being provided with a camera-readable pattern;
the projecting end portion being provided with at least one camera which is arranged to image the graphic pattern when said end portion is near the landing place;
the camera being connected in a signal-communicating manner to an image processor; and
the image processor being arranged to determine the position of the camera relative to the pattern by image analysis and convert the image information into control parameters for the control system to position the projecting end portion relative to the landing place.

The projecting end portion may be provided with at least two cameras, which are arranged in a spaced-apart manner, are unidirectional and have coinciding camera planes.

The projecting end portion may include a landing gear, which is at least partially within the field of view of the camera.

The elongated element may be a gangway, and the projecting end portion may be arranged to land at the landing place.

In a second aspect, the invention relates more specifically to a method of manoeuvring an elongated element which projects in a pivotable manner from a foundation and which is arranged to position a projecting end portion relative to a landing place remote from the foundation, the method including the step of
manoeuvring the element by means of several actuators connected to a control system, characterized by the method including the further steps:
providing the landing place with a camera-readable pattern;
providing the projecting end portion with at least one camera which is arranged to image the pattern when said end portion is near the landing place;
connecting the camera in a signal-communicating manner to an image processor;
by an image analysis in the image processor, determining the position of the camera relative to the pattern and converting the image information into control parameters for the control system; and
positioning the projecting end portion relative to the landing place.

The method may include the further step of continuously updating the control parameters.

The method may include the further step of performing a landing of the projecting end portion or an element suspended from the projecting end portion at the landing place automatically by continuous updating of the control parameters for the control system.

In a third aspect, the invention relates more specifically to the use of an image processor for generating control parameters for a control system for positioning a projecting end portion of an elongated element, which projects in a pivotable manner from a foundation, relative to a landing place remote from the foundation.

The elongated element may be a gangway.

### BRIEF DESCRIPTION OF THE DRAWINGS

In what follows, an example of a preferred embodiment is described, which is visualized in the accompanying drawings, in which:

FIG. 1 shows, in perspective, an elongated element in the form of a gangway which is provided, in an outer end portion, with a landing gear and a camera rig including two cameras, the outer end portion of the gangway being positioned over a landing place provided with a camera-readable pattern in the form of equally spaced graphic objects;

FIG. 2a shows a front view of the outer end portion with the landing gear and the camera rig;

FIG. 2b shows a side view of the outer end portion with the landing gear and the camera rig;

FIGS. 3a and 3b show the landing place seen from the first camera (FIG. 3a) and a second camera (FIG. 3b) with lens axes perpendicular to the landing place and an image base line parallel to a side edge of the landing place;

FIG. 4 shows an image composed of images from the first and second cameras represented in FIGS. 3a and 3b, the imaged distance between identical objects being indicated;

FIG. 5 shows the landing place seen from the first camera when a lens axis is perpendicular to the landing place and the image base line has been rotated relative to the landing place; and

FIG. 6 shows the landing place seen from the first camera when a lens axis is oblique to the landing place and the image base line is parallel to a side edge of the landing place.

### DETAILED DESCRIPTION OF THE DRAWINGS

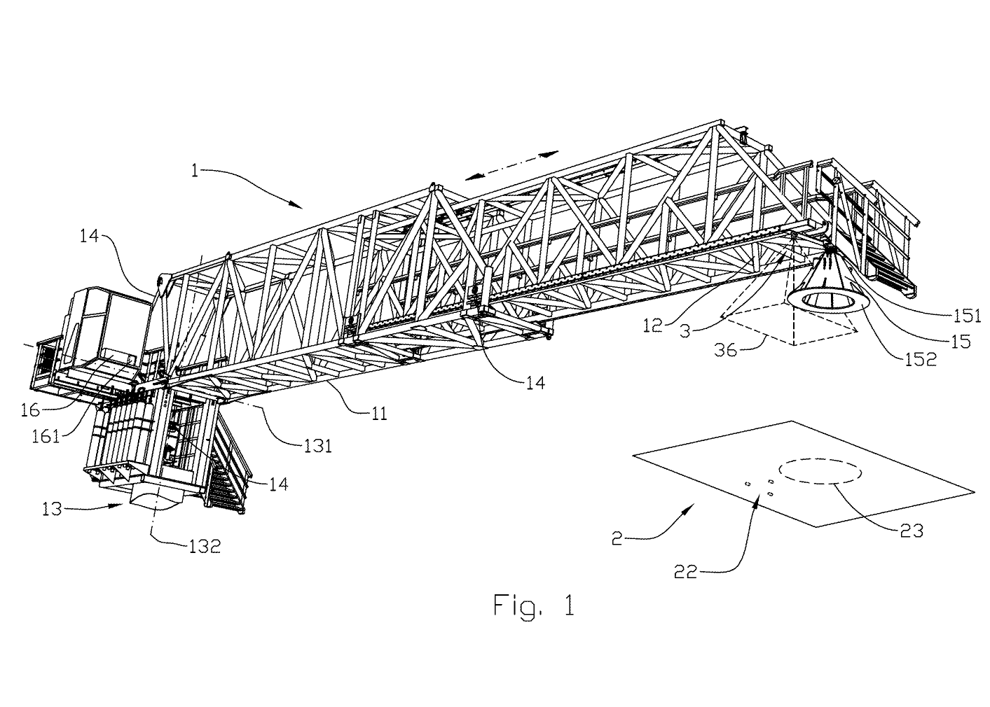

Reference is first made to FIG. 1, in which an elongated element 1, shown as a gangway here, projects from a foundation 13 which may be arranged on a vessel or a fixed installation (not shown), a first end portion 11 being supported around first and second rotary axes 131 and 132, respectively, and being telescopically extendable in order to, by means of actuators 14, be able to land a second, outer end portion 12 on a landing place 2 on an installation not shown, for example a vessel or a fixed installation at sea. The outer end portion 12 is appropriately provided with a landing gear 15, shown here as a conical element rotatably supported in a ball joint 151 in the outer end portion 12 and arranged to be securable to structures at the landing place 2 when the gangway 1 has landed in a preferred position indicated by a landing mark 23 in FIG. 1. A control system 16 is connected to several actuators 14 and a drive not shown, for example a hydraulic system including motor(s), pumps, valves, accumulators, hoses and pipes for the controlled supply of a pressurized fluid to the actuators.

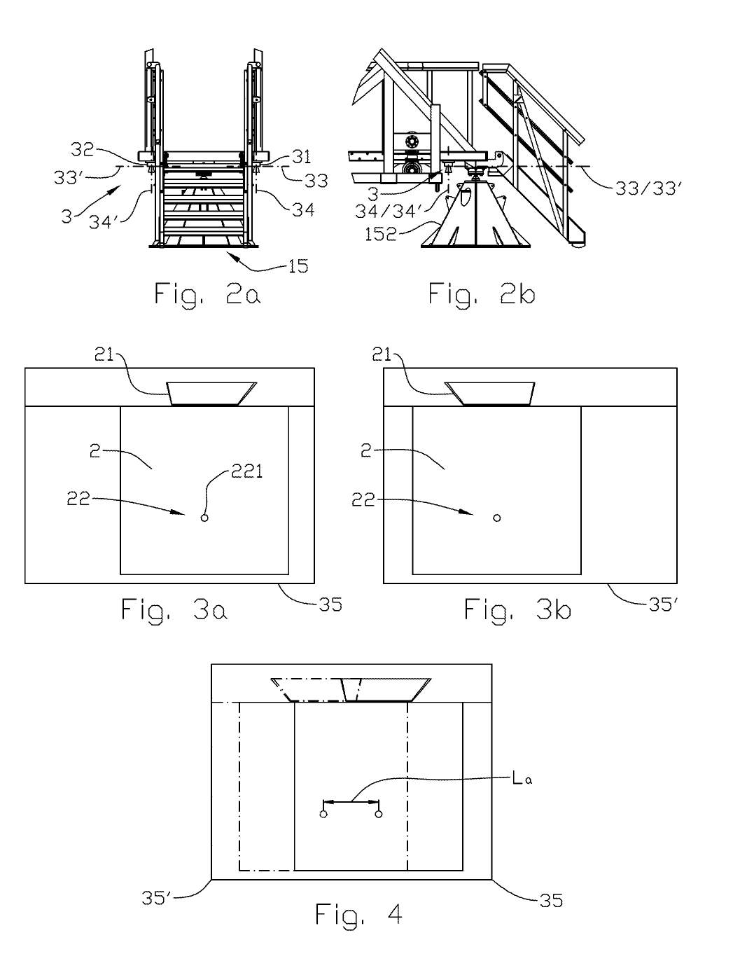

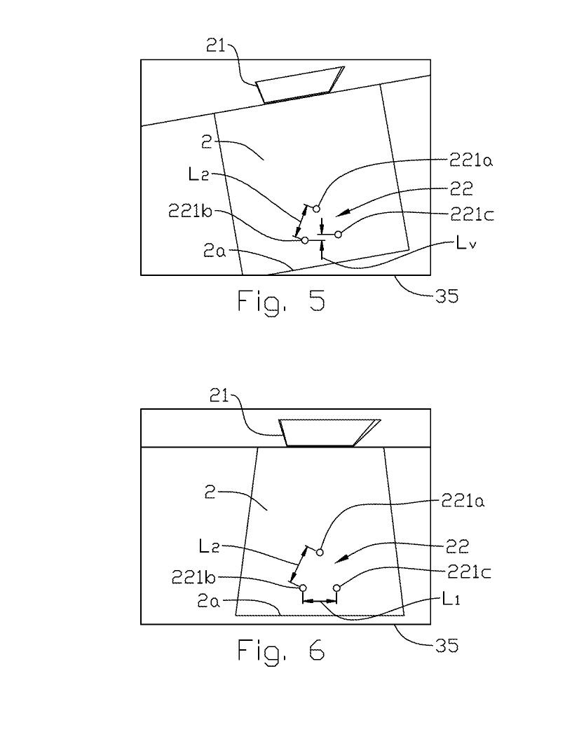

Reference is now made to FIGS. 2a and 2b in particular. In the immediate vicinity of the attachment of the landing gear 15 to the gangway 1, a camera assembly 3 is arranged, in which first and second cameras 31, 32 are arranged to image at least a lower portion 152 of the landing gear 15 and an area located below the landing gear 15. The cameras 31, 32 are set with lens axes 34, 34′ parallel to each other and coinciding camera planes 33, 33′ and image bases 35, 35′ (see FIGS. 3a and 3b) and are preferably arranged with the image bases 35, 35′, that is to say one image edge of the image, perpendicular to the longitudinal axis of the gangway 1. A camera field of view 36 is indicated in FIG. 1.

Reference is now made to FIGS. 3a and 3b in particular. The landing place 2, which is provided with an access 21, for example a gate, is provided with a camera-readable pattern 22 comprising one object 221.

Cameras that are sensitive to light of different wavelengths from those of visible light may be used.

When the landing place 2 is identified by means of the graphic pattern 22 imaged by both cameras, illustrated by the representations according to FIGS. 3a and 3b, the images are paired into a combined image as is shown in FIG. 4, and the distance Lₐ read between the representations of the graphic object 221 can be used together with the known distance between the cameras 31, 32 in the camera rig 3 to calculate the distance from the camera plane 33 to the landing place 2.

These calculations are carried out by an image processor 161 and are converted into control parameters for the control system 16 for the actuators 14 of the gangway 1. By a continuous processing of the image information, the control system 16 can be constantly updated with new control parameters until the gangway 1 has landed at the landing place 2.

By calculating the imaged spacing of three objects 221a, 221b, 221c which are arranged in an equally spaced manner in the pattern 22 at the landing place 2, as is shown in FIGS. 5 and 6, the image analysis may also, in addition to giving information about the distance between the gangway 1 and the landing place 2, give information, about the angling of the gangway 1 relative to the landing place 2.

FIG. 5 shows a situation imaged by the first camera 31, in which the lens axis 34 is perpendicular to the landing place 2, but the camera 31 has been rotated so that the image base line 35 is not parallel to a front (represented as the bottom) side edge 2a of the landing place 2. The imaged distance Lᵥ can be used as an indicator of the rotation, by comparison with the imaged distance L₂, among other things.

FIG. 6 shows a situation imaged by the first camera 31, in which the lens axis 34 is at an angle, whereas the image base line 35 is parallel to the front side edge 2a of the landing place 2. Among other things, the relationship between the imaged distances L₁ and L₂ can be used as an indicator of the slant of the lens axis 34.

The analytical result of a set of images can also be checked, be verified, that is, by comparing the result with analytical results from earlier stages in the ongoing landing operation.

The control parameters that are generated by the image analyses can be used for automatically manoeuvring the elongated element 1, especially in critical stages as during landing of the projecting end portion 12 of a gangway at the landing place 2, but also of other elongated, projecting elements, for example a crane boom.

It should be noted that all the above-mentioned embodiments illustrate the invention, but do not limit it, and persons skilled in the art may construct many alternative embodiments without departing from the scope of the dependent claims. In the claims, references in brackets are not to be regarded as restrictive. The use of the verb “to comprise” and its different forms, does not exclude the presence of elements or steps that are not mentioned in the claims. The indefinite article “a” or ^{“}an^{”} before an element does not exclude the presence of several such elements.

The fact that some features are stated in mutually different dependent claims does not indicate that a combination of these features cannot be used with advantage.

1. A control system for maneuvering an elongated element which projects in a pivotable manner from a foundation and which is arranged to position a projecting end portion relative to a landing place remote from the foundation, the maneuvering being provided by one or more actuators connected to the control system, wherein:
the landing place is provided with a camera-readable pattern;
the projecting end portion is provided with at least one camera which is arranged to image the graphic pattern when said end portion is near the landing place;
the at least one camera is connected in a signal-communicating manner to an image processor; and
the image processor is arranged to determine the position of the at least one camera relative to the pattern by image analysis and convert the image information into control parameters for the control system to position the projecting end portion relative to the landing place.

2. The control system according to claim 1, wherein the projecting end portion is provided with at least two cameras which are arranged in a spaced-apart manner and are unidirectional and have coinciding camera planes.

3. The control system according to claim 1, wherein the projecting end portion includes a landing gear which is at least partially inside the field of view of the at least one camera.

4. The control system according to claim 1, wherein the elongated element is a gangway, and wherein the projecting end portion is arranged to land on the landing place.

5. A method of manoeuvring maneuvering an elongated element which projects in a pivotable manner from a foundation and is arranged to position a projecting end portion relative to a landing place remote from the foundation, the method comprising:
maneuvering the element by several actuators connected to a control system,
providing the landing place with a camera-readable pattern;
providing the projecting end portion with at least one camera which is arranged to image the pattern when said end portion is near the landing place;
connecting the at least one camera in a signal-communicating manner to an image processor;
by an image analysis in the image processor, determining the position of the at least one camera relative to the pattern and converting the image information into control parameters for the control system; and
positioning the projecting end portion relative to the landing place.

6. The method according to claim 5, further comprising:
continuously updating the control parameters.

7. The method according to claim 5, further comprising:
performing a landing of the projecting end portion, or an element suspended from the projecting end portion, at the landing place, automatically by a continuous updating of the control parameters for the control system.

8. (canceled)

9. (canceled)
